(19) United States
(12) Patent Application Publication
(10) Pub. No.: US 2019/0332256 A1
(43) Pub. Date: Oct. 31, 2019

(54) SCREEN TRANSMISSION METHOD AND SCREEN TRANSMISSION SYSTEM

(71) Applicant: FUJITSU LIMITED, Kawasaki-shi (JP)

(72) Inventors: YUKIHIKO FURUMOTO, Kawasaki (JP); Yoshiyuki KATO, Kawasaki (JP)

(73) Assignee: FUJITSU LIMITED, Kawasaki-shi (JP)

(21) Appl. No.: 16/385,855

(22) Filed: Apr. 16, 2019

(30) Foreign Application Priority Data
Apr. 25, 2018 (JP) 2018-084371

(51) Int. Cl. G06F 3/0484; G06F 3/0488

(52) U.S. Cl. CPC G06F 3/04847; G06F 3/04886

(57) ABSTRACT

A screen transmission system includes a first memory and a first processor coupled to the first memory. The first processor is configured to transmit first part of screen data by using a first communication protocol. The first processor is configured to transmit second part of the screen data by using a second communication protocol that is higher in transmission speed and lower in communication reliability than the first communication protocol.

### CROSS-REFERENCE TO RELATED APPLICATION

This application is based upon and claims the benefit of priority of the prior Japanese Patent Application No. 2018-84371, filed on Apr. 25, 2018, the entire contents of which are incorporated herein by reference.

### FIELD

The embodiments discussed herein are related to a screen transmission method and a screen transmission system.

### BACKGROUND

A data transmitting device has been proposed that individually transmits, to a client apparatus, a command and display data which correspond to an execution result of processing requested by the client apparatus.

For example, a data transmitter calculates a rate of change by using a difference between display data and previous display data, and transmits, when the rate of change is smaller than a threshold, a difference in the display data to a client apparatus by using a first communication protocol (for example, the Transmission Control Protocol (TCP)). When the rate of change is larger than or equal to the threshold, the data transmitter transmits the difference in the display data to the client apparatus by using a second communication protocol (for example, the User Datagram Protocol (UDP)).

Related techniques are disclosed in, for example, Japanese Laid-open Patent Publication No. 2009-140378.

In the above-described scheme, however, in either of the communication protocols, when arrival of data to be received by the client apparatus is delayed, it takes a certain waiting time in order to determine whether the arrival of the data is delayed or the data is lost. Consequently, there are cases in which performance in increasing the communication speed deteriorates.

### SUMMARY

According to an aspect of the present invention, provided is a screen transmission system including a first memory and a first processor coupled to the first memory. The first processor is configured to transmit first part of screen data by using a first communication protocol. The first processor is configured to transmit second part of the screen data by using a second communication protocol that is higher in transmission speed and lower in communication reliability than the first communication protocol.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating re-transmission processing of data lost during communication;

FIG. 2 is a diagram illustrating an example of the configuration of a screen transmission/reception system according to an embodiment and the functional configurations of the server apparatus and the client apparatus;

FIG. 3 is a diagram illustrating an example of the hardware configuration of a server apparatus according to the embodiment;

FIG. 4 is a flowchart illustrating one example of screen transmission processing according to the first example;

FIG. 5 illustrates an example of a window at-a-glance table according to the first example;

FIG. 6 is a diagram illustrating the screen transmission processing according to the first example;

FIG. 7 is a flowchart illustrating an example of screen transmission processing according to a second example;

FIG. 8 is a diagram illustrating the screen transmission processing according to the second example;

FIG. 9 is a flowchart illustrating an example of screen transmission processing according to a third example;

FIG. 10 is a diagram illustrating the screen transmission processing according to the third example;

FIG. 11 is a flowchart illustrating an example of screen transmission processing according to the fourth example;

FIG. 12 illustrates an example of a management table according to the fourth example;

FIG. 13 is a diagram illustrating another example of the functional configurations of the server apparatus and the client apparatus in the screen transmission/reception system according to the embodiment;

FIG. 14 is a flowchart illustrating an example of the screen transmission processing according to the fifth embodiment; and

FIG. 15 is a diagram illustrating operation transmission processing according to the fifth embodiment.

### DESCRIPTION OF EMBODIMENTS

Embodiments will be described below with reference to the accompanying drawings. Herein and in the accompanying drawings, constituent elements having substantially the same functional configuration are denoted by the same reference numerals, and redundant descriptions are not given.

In a virtual desktop (a virtual desktop infrastructure (which may hereinafter be referred to as a “VDI”), a client apparatus operates a server apparatus at a remote location to display, on the client apparatus, a screen of a desktop image of the server apparatus (this screen may hereinafter be referred to as a “desktop screen”). The virtual desktop is a system on which a user performs interactive operation, and it is important that the virtual desktop have response performance that is equivalent to that in a case in which a general desktop is used.

In the virtual desktop, a user operation performed on the client apparatus is transferred to the server apparatus and is subjected to processing by a VDI application 113 that operates on the server apparatus, and a desktop screen generated by the server apparatus is transmitted to the client apparatus. The transmitted desktop screen is displayed on a screen of the client apparatus.

Compared with operations in ordinary computers, the virtual desktop differs in that operations and the desktop screen are transferred through a network. Thus, in order to realize response performance that is equivalent to that in a case in which a general desktop is used, high-speed data communication is to be performed between the server apparatus and the client apparatus.

The Transmission Control Protocol (TCP) and the User Datagram Protocol (UDP) are examples of communication protocols used by the virtual desktop system. The TCP has a mechanism for guaranteeing the reliability of data that is communicated using the protocol. Hence, in the virtual desktop system, processing is executed predicated on reliability of transferred data.

On the other hand, the UDP has no mechanism for guaranteeing the reliability, although it is high in transmission speed. That is, UDP is lower in communication reliability than TCP. Thus, in the virtual desktop system, a mechanism for guaranteeing the reliability is realized in a protocol for a virtual desktop implemented on the UDP, as described below. The TCP has a mechanism described below.

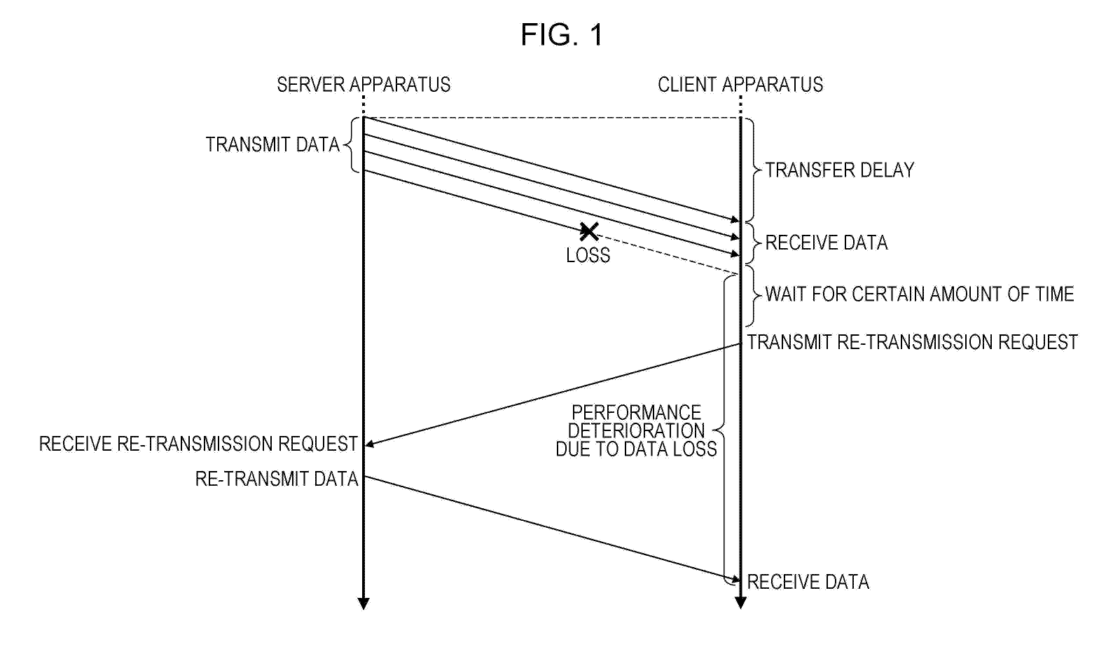

One example of a mechanism (processing) for guaranteeing the reliability in a protocol for a virtual desktop is a mechanism for re-transmitting data lost during communication. That is, for example, a protocol without a mechanism for re-transmitting data lost during communication is lower in communication reliability than a protocol without the mechanism for re-transmitting data lost during communication. An example of processing for re-transmitting data lost during communication will be described with reference to FIG. 1. FIG. 1 is a diagram illustrating re-transmission processing of data lost during communication.

When a server apparatus transmits data, a client apparatus receives the data through a network. Since it takes a communication time for the client apparatus to receive the data transmitted through the network, a transfer delay occurs. When the client apparatus does not receive the data from the server apparatus, the client apparatus waits for a certain amount of time in order to determine whether the arrival of the data is delayed or the data is lost during the transmission.

When the client apparatus does not receive the data to be received after waiting for the certain amount of time, the client apparatus transmits a re-transmission request. Upon receiving the re-transmission request, the server apparatus re-transmits the data, and the client apparatus receives the re-transmitted data. Thus, the total time of the certain waiting time and a time from issuance of the re-transmission request to reception of the re-transmitted data when data is lost occurs as deterioration of performance, for example, delay in the processing.

In a communication protocol realized in UDP, when loss of part of data occurs, performing processing without re-transmitting the lost data does not involve the re-transmission time, thus making it possible to improve the performance. In this case, however, when the client apparatus does not receive data to be received, it is desirable to determine whether or not the data is lost or the arrival of the data is delayed. In this case, the certain waiting time illustrated in FIG. 1 occurs as deterioration of the performance, for example, delay in the processing.

A screen transmission/reception system according to an embodiment described below does not involve a certain waiting time even when data to be received is not received and is adapted to realize performance as high as possible.

For example, when a data transmitting end determines whether or not data to be transmitted is data that has to be processed by a receiving end or data that does not have to be processed by the receiving end. The data that does not have to be processed corresponds to, for example, data for displaying more details on a screen in a VDI or data for making motion on the screen more smoothly.

The data that has to be processed by a receiving end is transmitted from a transmitting end to the receiving end by using a communication protocol that guarantees the reliability. In the communication protocol that guarantees the reliability, re-transmission processing is performed when data loss occurs.

On the other hand, the data that does not have to be processed by the receiving end is transmitted from the transmitting end to the receiving end by using a communication protocol that does not guarantee the reliability and that is high in transmission speed. Even when the data to be received is not received, the receiving end neither waits for a certain amount of timer and nor issues a re-transmission request. When data loss occurs, the re-transmission is not performed, either.

Since the communication protocol that guarantees the reliability ensures that the receiving end receives the data that has to be processed thereby, the receiving end performs processing in a normal manner. On the other hand, with respect to the data that does not have to be processed, the receiving end performs processing on the data that it successfully receives and disregards the data that it fails to receive. Thus, not only is no re-transmission time involved, but also the certain waiting time (illustrated in FIG. 1) for determining that the data is not received is not involved, thus making it possible to improve the performance.

[Configuration of Screen Transmission/Reception System and Functional Configurations of Server Apparatus and Client Apparatus]

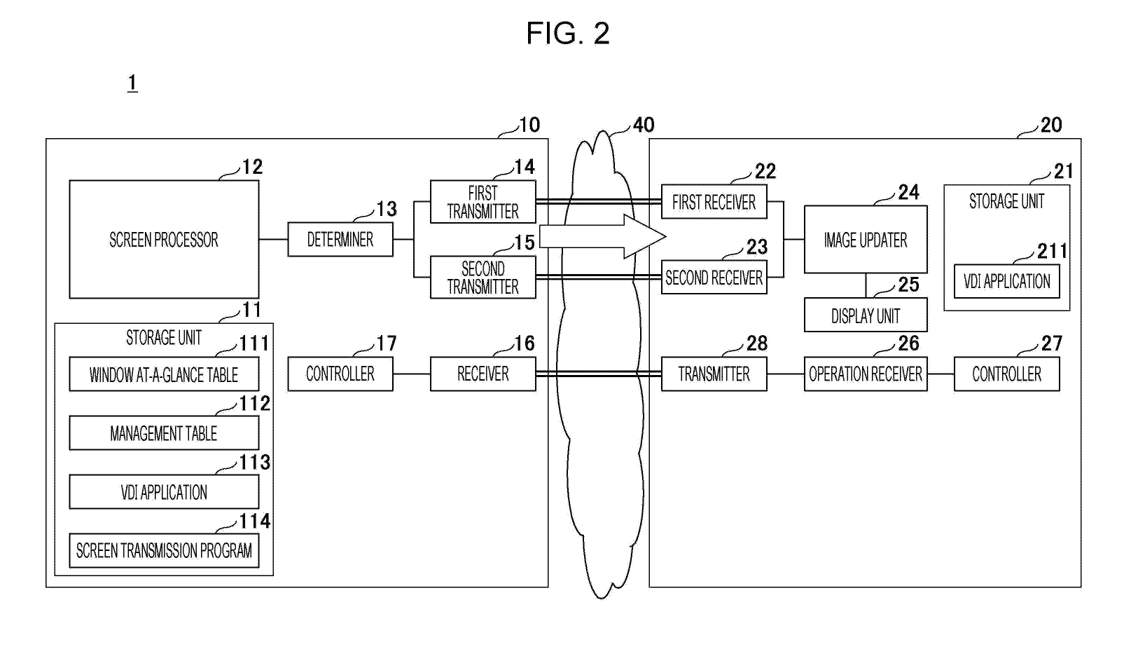

An example of the configuration of a screen transmission/reception system according to the embodiment which executes the above-described processing and functional configurations of the server apparatus and the client apparatus will be described with reference to FIG. 2. FIG. 2 is a diagram illustrating an example of the configuration of a screen transmission/reception system according to the embodiment and the functional configurations of the server apparatus and the client apparatus.

A screen transmission/reception system 1 includes a server apparatus 10 and a client apparatus 20. Although one client apparatus 20 is illustrated in FIG. 1, the number of client apparatuses 20 is not limited to one and may be two or more. The number of server apparatus 10 is not limited to one and may be two or more. The server apparatus 10 and the client apparatus 20 are connected to each other through a network 40.

In the screen transmission/reception system 1, the server apparatus 10 at a remote location is operated from the client apparatus 20, and a desktop screen of the server apparatus 10 is displayed on the client apparatus 20 to thereby provide a virtual desktop (VDI) service.

The client apparatus 20 in the VDI includes a storage unit 21, a first receiver 22, a second receiver 23, an image updater 24, a display unit 25, an operation receiver 26, a controller 27, and a transmitter 28. The storage unit 21 stores a VDI application program (hereinafter referred to as a “VDI application 211”). The controller 27 execute the VDI application 211, and the operation receiver 26 receives an operation of a user. The transmitter 28 transmits predetermined information to the server apparatus 10 and other devices.

The server apparatus 10 in the VDI includes a storage unit 11, a screen processor 12, a determiner 13, a first transmitter 14, a second transmitter 15, a receiver 16, and a controller 17. The receiver 16 receives predetermined information from the client apparatus 20 and other devices. The controller 17 and the screen processor 12 generate a desktop screen by executing a VDI application program (hereinafter referred to as a “VDI application 113”) stored in the storage unit 11.

Data of the generated desktop screen is transmitted to the client apparatus 20 by using a communication protocol that differs depending on whether or not the reliability of the data is to be guaranteed. Accordingly, the determiner 13 determines whether or not the data has to be processed by the client apparatus 20 at the receiving end.

The first transmitter 14 transmits data by using a first communication protocol that has a mechanism for guaranteeing the reliability and that ensures that the data is transferred to the client apparatus 20 at a receiving end via re-transmission of the data. The second transmitter 15 transmits data by using a second communication protocol that does not have a mechanism for guaranteeing the reliability and with which the speed of the data transmission is increased.

When it is determined that the generated desktop screen data is data that has to be processed by the client apparatus 20, the first transmitter 14 transmits the desktop screen data to the client apparatus 20 by using the first communication protocol that guarantees the reliability. On the other hand, when it is determined that the generated desktop screen data is data that does not have to be processed by the client apparatus 20, the second transmitter 15 transmits the desktop screen data to the client apparatus 20 by using the second communication protocol that does not guarantee the reliability.

The following description will be given in conjunction with the TCP, which is an example of the first communication protocol that guarantees the reliability, and the UDP, which is an example of the second communication protocol that does not guarantee the reliability. The first communication protocol that guarantees the reliability, however, may be another protocol or UDP that has a mechanism in which a certain amount of time is waited for in order to detect unreceived data and the data is re-transmitted when the unreceived data is not sensed. The first communication protocol that guarantees the reliability may be implemented by any protocol that has a mechanism in which data transmitted by the server apparatus 10 fully arrives at the client apparatus 20.

On the other hand, the second communication protocol that does not guarantee the reliability does not have a mechanism in which data transmitted by the server apparatus 10 fully arrives at the client apparatus 20 in all instances. The second communication protocol that does not guarantee the reliability may be another protocol or UDP with which a certain amount of time is not waited for in order to sense unreceived data and that does not have a mechanism for re-transmitting the unreceived data. The second communication protocol that does not guarantee the reliability does not involve a certain waiting time for sensing unreceived data and a time from issuance of a re-transmission request to re-transmission of the data, and thus, the speed of data communication is higher than that in the first communication protocol.

The first receiver 22 in the client apparatus 20 receives screen data transmitted from the first transmitter 14. The second receiver 23 receives screen data transmitted from the second transmitter 15. The image updater 24 updates an image, based on the screen data received by the first receiver 22 and the second receiver 23 and displays the resulting image on the display unit 25. Thus, the screen generated by the server apparatus 10 is displayed on a screen of the client apparatus 20. When the first receiver 22 does not receive data to be received, the first receiver 22 waits for a certain amount of time and then transmits a re-transmission request to the server apparatus 10 (see FIG. 1). The second receiver 23 does not sense whether or not data arrives, and when data does not arrive, the second receiver 23 disregards the data.

A window at-a-glance table 111, a management table 112, the VDI application 113, and a screen transmission program 114 are stored in the storage unit 11. The screen transmission program 114 determines which of the first communication protocol that guarantees the reliability and the second communication protocol that does not guarantee the reliability is to be used to transmit the desktop screen data. In accordance with a result of the determination, the screen transmission program 114 causes the server apparatus 10 to execute processing for transmitting the screen data.

Each of the server apparatus 10 and the client apparatus 20 may be any of information processing devices, such as a personal computer, a tablet-computer terminal, a smartphone, a head mount display (HMD), and a watch-type wearable display device.

[Hardware Configurations of Server Apparatus 10 and Client Apparatus 20]

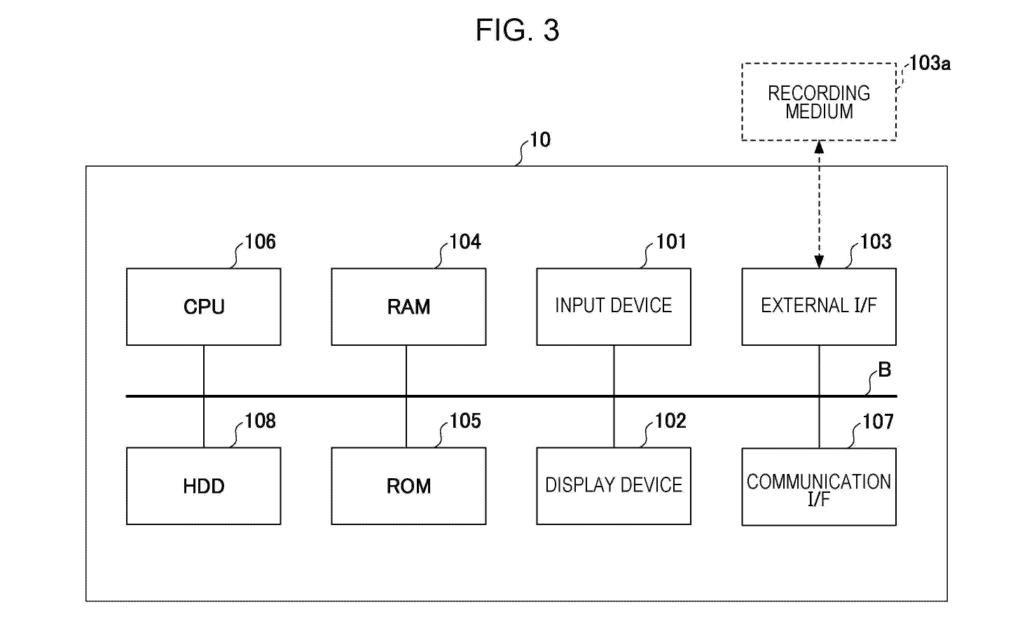

Next, the hardware configurations of the server apparatus 10 and the client apparatus 20 according to the embodiment will be described with reference to FIG. 3. FIG. 3 is a diagram illustrating an example of the hardware configuration of the server apparatus 10 according to the embodiment. The hardware configuration of the server apparatus 10 will be described below, and the description of the client apparatus 20 having substantially the same or hardware configuration is not given.

The server apparatus 10 includes an input device 101, a display device 102, an external interface (I/F) 103, a random-access memory (RAM) 104, a read-only memory (ROM) 105, and a central processing unit (CPU) 106. The server apparatus 10 further includes a communication I/F 107 and a hard disk drive (HDD) 108. The individual elements in the server apparatus 10 are connected to each other through a bus B.

The input device 101 includes a keyboard, a mouse, and so on and is used to receive a user operation and so on. The display device 102 includes a display, such as a liquid-crystal display (LCD) or a cathode ray tube (CRT) display, a printer, and so on and displays generated screen data and other information. The communication I/F 107 is an interface for connecting the server apparatus 10 to the network 40. This allows the server apparatus 10 to transmit the screen data to the client apparatus 20 and to receive operation information via the communication I/F 107.

The HDD 108 is a nonvolatile storage device in which programs and data are stored. Examples of the programs and data that are stored include basic software that controls the entire server apparatus 10 and application software. For example, various databases, programs, and so on may be stored in the HDD 108.

The external I/F 103 is an interface for an external device. The external device is, for example, a recording medium 103a. This allows the server apparatus 10 to perform reading from and/or writing to the recording medium 103a via the external I/F 103. The recording medium 103a may be a compact disk (CD) or a digital versatile disk (DVD). The recording medium 103a may be a Secure Digital (SD) memory card or a Universal Serial Bus (USB) memory.

The ROM 105 is a nonvolatile semiconductor memory that is capable of holding data therein even when power supply is turned off. Programs and data for network setting and so on are stored in the ROM 105. The RAM 104 is a volatile semiconductor memory that temporarily holds programs and data. The CPU 106 is a computing device that controls the entire apparatus and that realizes functions thereof by reading programs and data from a storage device, such as the HDD 108 or the ROM 105, into the RAM 104 and executing processing.

With this configuration, in the server apparatus 10 according to the present embodiment, the CPU 106 executes screen transmission processing, for example, by using the programs and data stored in the RAM 104, the ROM 105, and the HDD 108.

For example, the functions of the screen processor 12, the determiner 13, and the controller 17 may be realized by processing that the screen transmission program 114 causes the CPU 106 to execute. The functions of the first transmitter 14, the second transmitter 15, and the receiver 16 may be realized by, for example, the communication I/F 107. The functions of the storage unit 11 may be realized by, for example, the RAM 104, the ROM 105, and the HDD 108.

Information stored in the window at-a-glance table 111 and the management table 112 may be stored in the RAM 104, the HDD 108, or a storage unit in a cloud computer connected to the server apparatus 10 through the network 40. The functions of the screen processor 12, the determiner 13, and the controller 17 may be executed by a plurality of cloud computers and/or fog computers connected to the server apparatus 10, instead of being executed by the CPU 106.

### FIRST EXAMPLE

[Screen Transmission Processing]

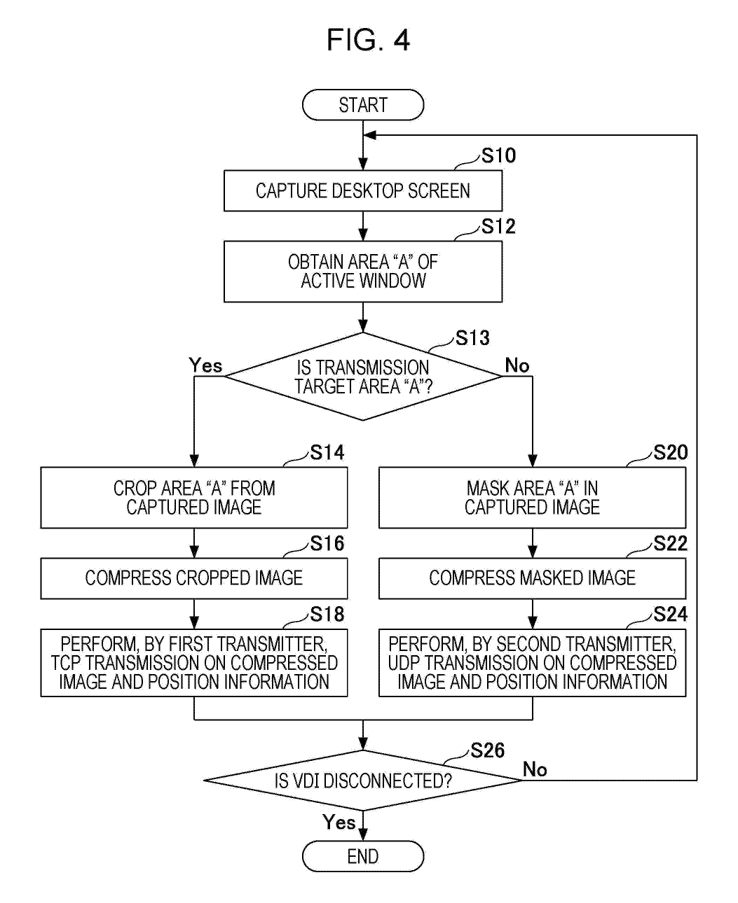

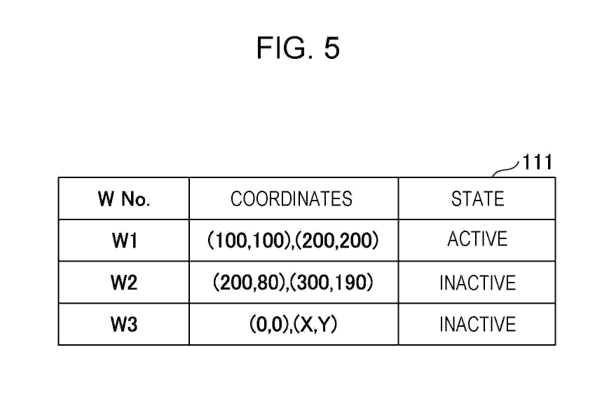

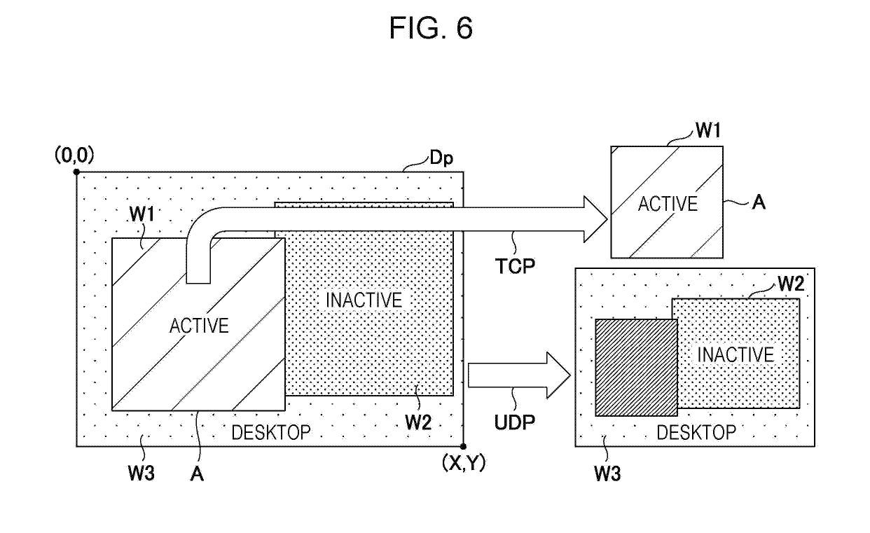

Next, one of screen transmission processing according to the first example will be described with reference to FIGS. 4 to 6. FIG. 4 is a flowchart illustrating one example of the screen transmission processing according to the first example. FIG. 5 illustrates an example of the window at-a-glance table 111 according to the first example. FIG. 6 is a diagram illustrating the screen transmission processing according to the first example. The server apparatus 10 executes the screen transmission processing.

In a window system, such as Windows®, an active window can be regarded as an area to which a user is paying attention. Accordingly, in the first example, in a VDI, screen data of an area on which the user is focusing attention is communicated using a TCP that guarantees the reliability, to ensure screen update using the screen data received by the client apparatus 20. On the other hand, a screen change in an area to which the user is not paying attention, for example, a screen change in an area of a non-active window (an inactive window), is regarded as not having to be reflected in the client apparatus 20, and thus the screen change is communicated using the UDP that does not guarantee the reliability, to thereby increase the communication speed. The TCP is an example of the first communication protocol that guarantees the reliability, and the UDP is an example of the second communication protocol that does not guarantee the reliability. The following description will be given of the screen transmission processing according to the first example.

When the client apparatus 20 operates the VDI application 211 to connect to the server apparatus 10, the screen processor 12 starts capturing a desktop screen (step S10). Next, the screen processor 12 obtains the area (hereinafter referred to as an “area A”) of an active window (step S12).

The area of the active window is obtained using the window at-a-glance table 111. The window at-a-glance table 111 illustrated in FIG. 5 stores window numbers (W No.) on a desktop screen, the positions (coordinates) of the windows, and the states of the windows. For example, a desktop screen Dp illustrated in FIG. 6 includes three windows W1, W2, and W3. The window W1 is in an active state, and the windows W2 and W3 are in an inactive state.

In this case, upper left coordinates (100, 100) of the window “W1”, and lower right coordinates (200, 200) thereof, and a state “active” are stored in the window at-a-glance table 111. Coordinates (200, 80) and (300, 190) of the window “W2”, and a state “inactive” are stored in the window at-a-glance table 111. Coordinates (0, 0) and (X, Y) of the window “W3” and a state “inactive” are stored.

Referring back to FIG. 4, in step S12, the screen processor 12 refers to the window at-a-glance table 111 to obtain the position and the size (coordinates) of the window “W1” as the area A of the active window. Next, the determiner 13 determines whether or not the reliability of communication for each transmission target is to be guaranteed (step S13).

Upon determining that the transmission target is the area A, the determiner 13 determines that the reliability for communication is to be guaranteed and then advances to step S14. In step S14, the screen processor 12 crops an image of the area A of the active window from the captured desktop screen Dp. In order to reduce the amount of data to be transferred, the screen processor 12 compresses the cropped image (step S16). The first transmitter 14 transmits the compressed image and coordinate data indicating position information of the area A of the active window to the client apparatus 20 by using the TCP (step S18). As a result, screen data relevant to the area A of the active window is transmitted to the client apparatus 20 by using the TCP that guarantees the reliability. This ensures that the image of the area A of the active window is reflected on the screen of the client apparatus 20.

If it is determined in step S13 that the transmission target is an area other than the area A, the determiner 13 determines that the reliability of the communication does not have to be guaranteed and advances to step S20. In step S20, the screen processor 12 masks the area A of the active window with respect to the captured desktop screen Dp, and in step S22, the screen processor 12 compresses the masked image.

For example, the screen processor 12 creates an image in which the area A is masked by blacking out the area A of the active window on the desktop screen Dp, as illustrated in FIG. 6. The screen processor 12 compresses the image in which the area A is masked in order to reduce the amount of data to be transferred. This allows the blacked-out area A to be compressed efficiently.

The second transmitter 15 transmits the compressed image and coordinates indicating the position information of the masked area A to the client apparatus 20 by using the UDP (step S24). As a result, the screen data other than the area A of the active window is transmitted to the client apparatus 20 by using the UDP that does not guarantee the reliability. This allows the screen data other than the area A of the active window to be transmitted with a high speed.

After the processes in step S18 and S24, a determination is made as to whether or not the VDI is disconnected (step S26). The loop processing of steps S10 to S26 is repeatedly executed until it is determined that the VDI execution by the VDI application 211 is disconnected. When it is determined that the VDI is disconnected, this processing ends.

According to the above-described processing, the server apparatus 10 determines and sorts desktop screen data that does not have to be processed by the client apparatus 20 and desktop screen data that has to be processed by the client apparatus 20. The server apparatus 10 transmits the former desktop screen data to the client apparatus 20 by using the second communication protocol that does not guarantee the reliability and that is high in transmission speed. The latter screen data is transmitted to the client apparatus 20 by using the first communication protocol that guarantees the reliability.

For example, in the first example, the screen data of an area other than the area A of an active window (for example, the screen data of the area of an inactive window), the screen data being data that does not have to processed by the client apparatus 20, is transmitted using a UDP communication protocol that does not guarantee the reliability and that is high in transmission speed. In the case of screen data of the area of an inactive window, re-transmission is not performed when the screen data is lost, and it does not take a certain waiting time for sensing whether or not the data is successfully received. Thus, the client apparatus 20 does not involve the certain waiting time for determining whether or not the screen data is successfully received and a re-transmission time including a re-transmission request, thus making it possible to improve the performance.

On the other hand, the screen data of the area A of the active window which has to be processed by the client apparatus 20 is transmitted from the server apparatus 10 to the client apparatus 20 by using a TCP communication protocol that guarantees the reliability. This ensures reception of the screen data of the area A of the active window to which the user is paying attention. Hence, in the case of the screen data of the area of an active window, re-transmission is performed when loss of the screen data occurs. With the above-described processing, it is possible to reliably transmit screen data that is to be transmitted, while maintaining the communication performance.

### SECOND EXAMPLE

[Screen Transmission Processing]

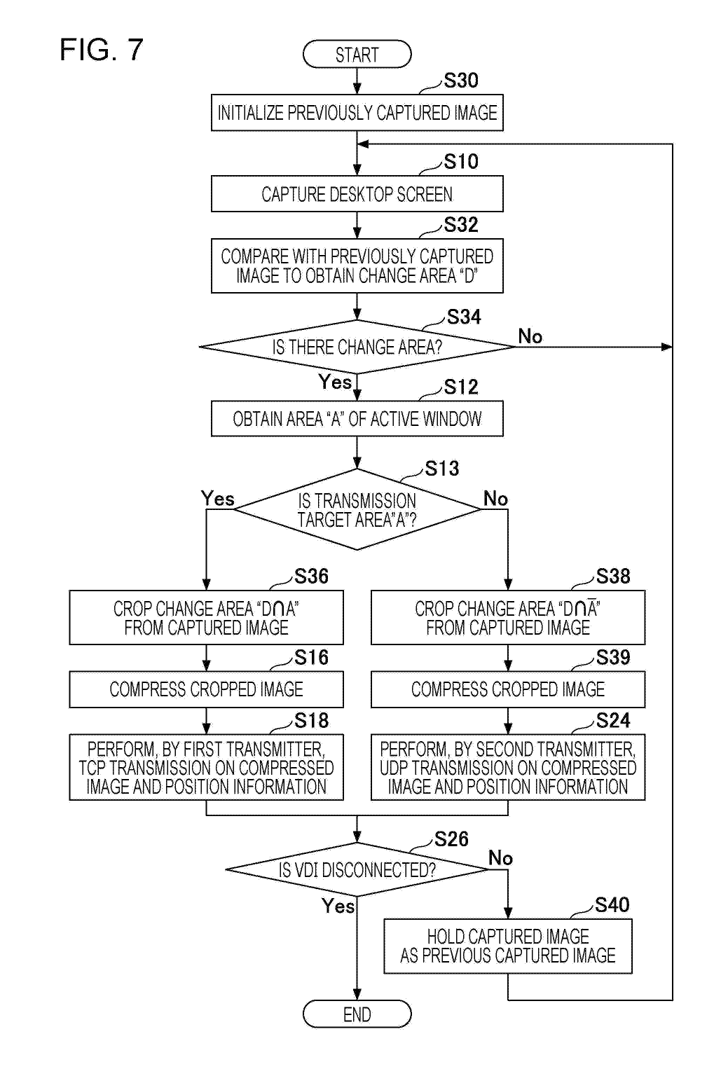

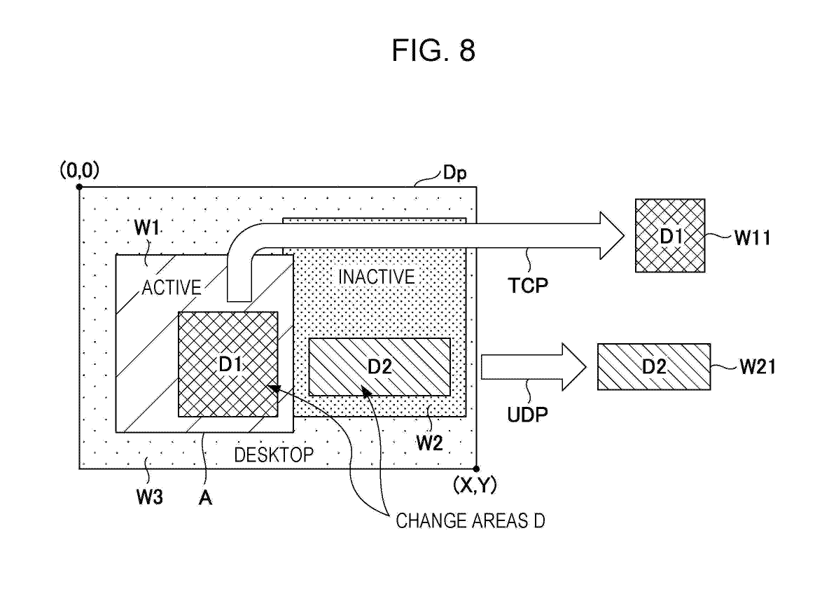

Next, one example of screen transmission processing according to the second example will be described with reference to FIGS. 7 and 8. FIG. 7 is a flowchart illustrating an example of the screen transmission processing according to the second example. FIG. 8 is a diagram illustrating the screen transmission processing according to the second example. This processing is mainly executed by the server apparatus 10.

In the second example, in order to make the screen transmission processing according to the first example more efficient, the screen data transmitted from the server apparatus 10 to the client apparatus 20 is limited to only an image of a part that is included in an entire image of the desktop screen and that has changed. A screen transmission processing according to the second example will be described below.

When the client apparatus 20 operates the VDI application 211 to connect to the server apparatus 10, the processing illustrated in FIG. 7 is started. The screen processor 12 initializes an image of a previously captured screen (step S30). The initialization of the image of the previously captured screen may use a blank image. Next, the screen processor 12 starts capturing a desktop screen (step S10).

Next, the screen processor 12 compares an image of a desktop screen captured in the current capture with the image of the previously captured desktop screen to detect a change area (hereinafter referred to as a “change area D”) in which an update has been performed on the desktop screen (step S32). Next, the screen processor 12 determines whether or not there is a change area D (step S34). When no update has been performed on the desktop screen, the screen processor 12 determines that there is no change area D and returns to step S10 in which the screen processor 12 captures a next desktop screen and repeats the processes in and after step S10.

When it is determined in step S34 that the desktop screen is updated, the screen processor 12 determines that there is a change area D and obtains the area of the active window (this area is hereinafter referred to as an “area A”) (step S12). Next, the determiner 13 determines whether or not the reliability of communication for each transmission target is to be guaranteed (step S13).

If the transmission target is the area A, the determiner 13 determines that the communication reliability is to be guaranteed and then advances to step S36. When the transmission target is an area other than the area A, the determiner 13 determines that the reliability of the communication does not have to be guaranteed and advances to step S38.

In step S36, the screen processor 12 crops an image of the change area D in the area A of the active window from the captured desktop screen Dp. As a result, for instance, in the example illustrated in FIG. 8, an image D1 is cropped. The screen processor 12 compresses the cropped image (step S16). The first transmitter 14 transmits the compressed image and position information of the cropped image to the client apparatus 20 by using the TCP (step S18). According to this processing, the screen data relevant to a change area D1 in the active window is transmitted to the client apparatus 20 by using the TCP that guarantees the reliability, as illustrated in FIG. 8. Thus, the image of the change area D1 in the active window is reliably reflected in the client apparatus 20.

The screen processor 12 crops an image of the change area D in an area other than the area A of the active window (for example, in the area of an inactive window) from the captured desktop screen Dp (step S38). As a result, for example, an image D2 is cropped in the example illustrated in FIG. 8. The screen processor 12 compresses the cropped image (step S39). The second transmitter 15 transmits the compressed image and position information of the image to the client apparatus 20 by using the UDP (step S24). According to this processing, screen data relevant to the change area D2 in the inactive window is transmitted to the client apparatus 20 by using the UDP that does guarantee the reliability and that is high in transmission speed. This makes it possible to reliably transmit screen data to be transmitted, while maintaining the communication performance.

After the processes in steps S18 and S24, a determination is made as to whether or not the VDI is disconnected (step S26). If it is determined that the VDI is not disconnected, the captured image acquired in the current capture is held as a previous captured image (step S40). Thereafter, the process returns to step S10, and the processing in and after step S10 is repeatedly executed until the VDI is disconnected. When it is determined in step S26 that the VDI is disconnected, the processing ends.

With the above-described screen transmission processing according to the second example, the screen data of a change area in an active window is transmitted using the TCP, and screen data of a change area in an inactive window is transmitted using the UDP. This makes it possible to reliably transmit screen data to be transmitted, while maintaining the communication performance. In the second example, since only change data on which a screen update is performed is transmitted from the server apparatus 10 to the client apparatus 20, the amount of the screen data of a transmission target decreases to make it possible to further increase the transmission speed of the screen data.

### THIRD EXAMPLE

[Screen Transmission Processing]

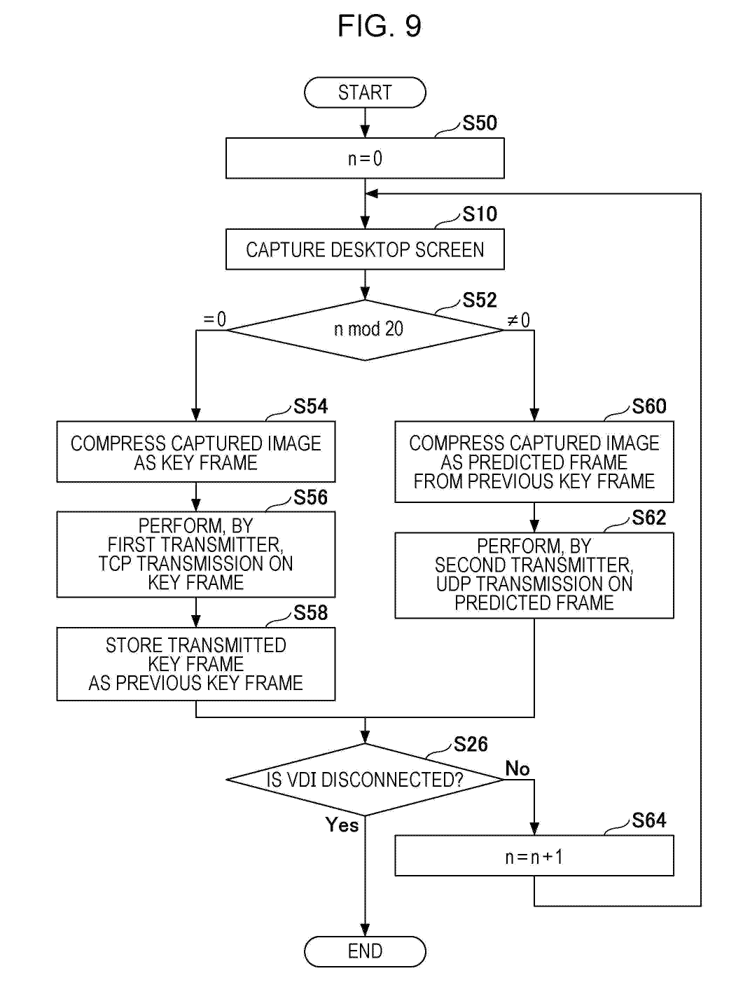

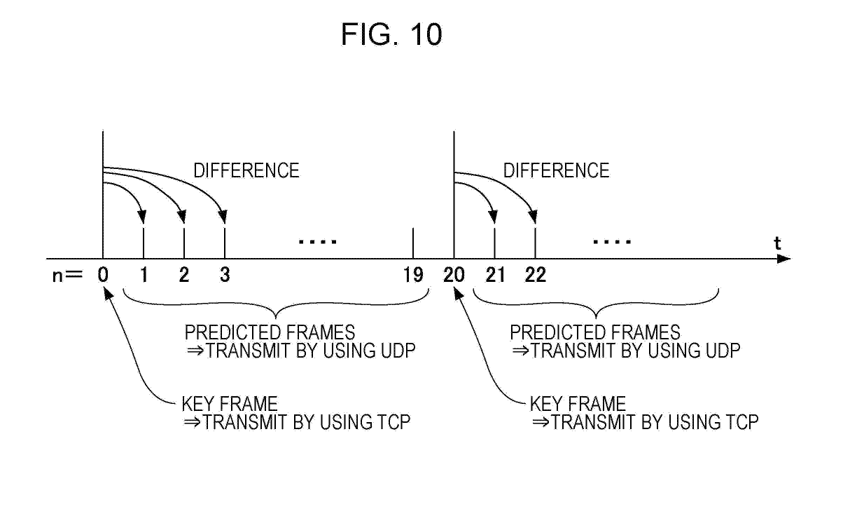

Next, an example of screen transmission processing according to the third example will be described with reference to FIGS. 9 and 10. FIG. 9 is a flowchart illustrating an example of the screen transmission processing according to the third example. FIG. 10 is a diagram illustrating the screen transmission processing according to the third example. This processing is mainly executed by the server apparatus 10.

In the third example, the server apparatus 10 transmits the desktop screen Dp to the client apparatus 20 as a moving image. The moving image is constituted by key frames in which the entire desktop screen Dp is compressed and predicted frames in which images of differences from the key frames are compressed. As illustrated in FIG. 10, the key frames are frames that are transmitted at regular intervals and that serve as references for transmitting the predicted frames and are used to transmit the entire desktop screen Dp. Accordingly, it is important that the key frames be reliably transmitted from the server apparatus 10 to the client apparatus 20. On the other hand, the predicted frames are images that compensate between the key frames and is used to transmit images of differences from the key frames. Accordingly, some of the predicted frames do not have to be transmitted to the client apparatus 20.

In the following description, a key frame is assumed to be transmitted every 20 frames, and a counter n is prepared in the flowchart in FIG. 9. When the remainder of dividing the counter n by 20 is 0, a key frame is transmitted; otherwise, a predicted frame is transmitted, as illustrated in FIG. 10. The following description will be given of the screen transmission processing according to the third example.

When the client apparatus 20 operates the VDI application 211 to connect to the server apparatus 10, the screen transmission processing in FIG. 9 is started. First, the screen processor 12 performs initialization processing for setting 0 for the counter n for switching between a key frame and a predicted frame (step S50). Next, the screen processor 12 starts capturing a desktop screen Dp (step S10).

Next, the determiner 13 determines whether or not the remainder of dividing the counter n by 20 is 0 (step S52). Upon determining that the remainder of dividing the counter n by 20 is 0, the determiner 13 determines that the transmission target is a key frame, and the reliability of the communication is to be guaranteed. Thereafter, the process proceeds to step S54. On the other hand, upon determining that the remainder of dividing the counter n by 20 is a value other than 0, the determiner 13 determines that the transmission target is a predicted frame, and the reliability of the communication does not have to be guaranteed. Thereafter, the process proceeds to step S60.

In step S54, the screen processor 12 compresses the captured image of the desktop screen as a key frame. The first transmitter 14 transmits the compressed key frame to the client apparatus 20 by using the TCP (step S56). Next, the screen processor 12 stores, as a previous key frame, the transmitted key frame in the storage unit 11 in order to create a subsequent predicted frame (step S58).

In step S60, the screen processor 12 compresses the captured image of the desktop screen as a predicted frame from the previous key frame. The second transmitter 15 transmits the compressed predicted frame to the client apparatus 20 by using the UDP (step S62).

After the processes in steps S58 and S62, a determination is made as to whether or not the VDI is disconnected (step S26). When it is determined that the VDI is not disconnected, the screen processor 12 increments the counter n by 1 in order to switch a next transmission target between a key frame and a predicted frame (step S64). The process returns to step S10, and the loop processing in and after step S10 is repeatedly executed until the VDI is disconnected. When it is determined in step S26 that the VDI is disconnected, the processing ends.

In the above-described screen transmission processing according to the third example, a key frame, which is an image of an entire screen, is transmitted using the TCP, and a predicted frame, which is an image of a difference from the key frame, is transmitted using the UDP, as illustrated in FIG. 10. This makes it possible to reliably transmit screen data to be transmitted, while maintaining the communication performance.

### FOURTH EXAMPLE

[Screen Transmission Processing]

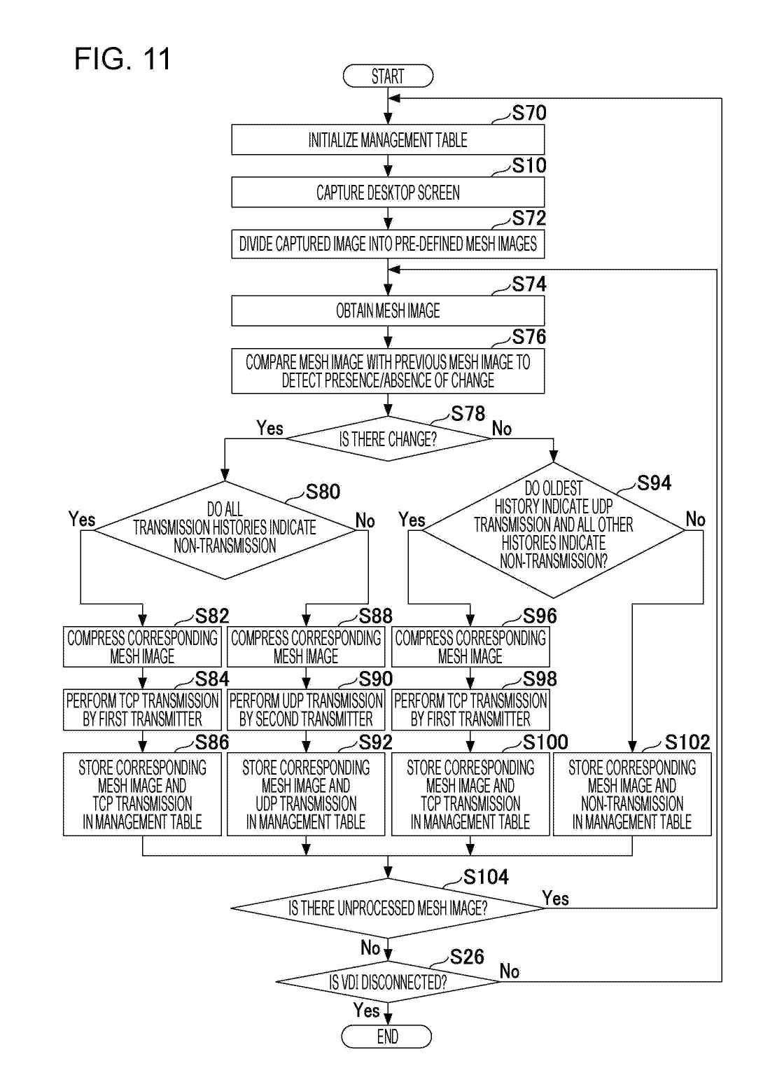

Next, an example of screen transmission processing according to a fourth example will be described with reference to FIG. 11. FIG. 11 is a flowchart illustrating an example of the screen transmission processing according to the fourth example. This processing is mainly executed by the server apparatus 10.

In the VDI, the amount of data that is transferred is commonly reduced by transmitting an image of an updated area only when the desktop screen is updated. For example, when an update of a screen on the server apparatus 10 with respect to a particular area of a desktop screen is not properly reflected at the client apparatus 20, what is displayed at the client apparatus 20 is updated when a next update of a screen at the server apparatus 10 is performed.

An area where an update is frequently performed and an area where an update is rare may exist on a desktop screen used in the VDI. It can be expected that, even when an area where an update is frequently performed is not properly reflected at the client apparatus 20, the desktop screen is immediately updated, and what is displayed at the client apparatus 20 is also normalized. Thus, it is permissible even when not all updates in the server apparatus 10 are reflected in the client apparatus 20. In contrast, in an area where an update is rare, when an update of a screen at the server apparatus 10 is not properly reflected at the client apparatus 20, there is a possibility that it takes a long time until what is displayed at the client apparatus 20 is normalized. Accordingly, it is important that the area where an update is rare be reliably reflected at the client apparatus 20.

Accordingly, in screen transmission processing, which is described below, according to the fourth example, screen data for an area where an update of a desktop screen is rare is transmitted using the TCP that guarantees the communication reliability, while referring to the management table 112. On the other hand, screen data for an area where an update is frequently performed is transmitted using the UDP that does not guarantee the communication reliability and that is high in transmission speed.

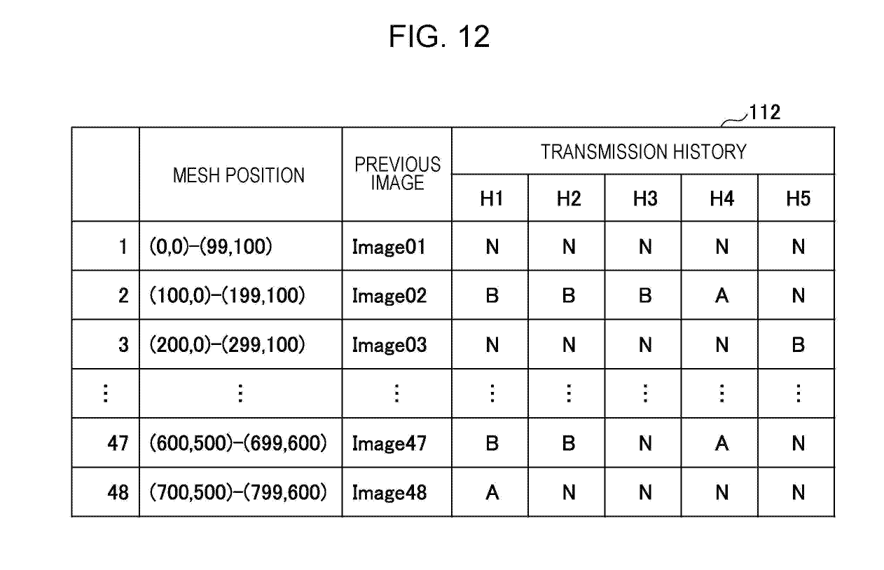

In the fourth example, the management table 112 is prepared in order to classify the area of a desktop screen into an area where the update frequency is high and an area where the update frequency is not so high and to manage the areas. FIG. 12 illustrates an example of the management table 112 according to the fourth example.

Mesh positions representing areas on a desktop screen, previous images indicating image data during previous capture for the respective mesh positions, and transmission histories (H1 to H5) managed with fixed-length queues are stored in the management table 112.

In this case, a description will be given of an example in which a desktop screen Dp with a resolution of 800×600 is divided into 48 meshes with a resolution of 100×100. The desktop screen is divided into 48 (=8×6) mesh images, by way of example.

A transmission history H1 indicates a transmission status for the most-recent capture, and a transmission history H5 indicates a transmission status for five captures ago. H2 to H4 indicate transmission statuses for two to four captures ago, respectively. Information A in the transmission history indicates TCP transmission, B indicates UDP transmission, and N indicates non-transmission. When a desktop screen is captured, and this processing is performed on each mesh image, the pieces of information in transmission history H1 to H4 are respectively shifted to the positions of H2 to H5 by one. Thus, the information in the transmission history H5 is discarded, and the most-recent transmission status is recorded in the information in the transmission history H1.

In the fourth example according to screen transmission processing in FIG. 11, when the client apparatus 20 operates the VDI application 211 to connect to the server apparatus 10, first, the screen processor 12 initializes the management table 112 (step S70). In the initialization of the management table 112, records for respective divided mesh areas are created, all previous mesh images are made to be blank images, and the transmission histories are set to N.

Next, the screen processor 12 starts capturing a desktop screen Dp (step S10). Upon capturing the desktop screen Dp, the screen processor 12 divides an image of the desktop screen Dp into images of respective areas (the images may hereinafter be referred to as “mesh images”) (step S72) and performs the following processing on each of the areas for the corresponding mesh images.

The screen processor 12 obtains the mesh image of one of the areas (step S74). The determiner 13 compares the obtained mesh image with a previous mesh image of the area to detect the presence/absence of a change (step S76). The determiner 13 determines whether or not there is a change in the mesh image of the area on the desktop screen Dp (step S78).

Upon determining that there is a change in the mesh image of the area, the determiner 13 refers to the management table 112 to determine transmission histories of the area (step S80). Upon determining that all of the transmission histories H1 to H5 of the area indicate N (non-transmission), the determiner 13 regards a screen change as being rare, since an image of the area has not been transmitted in the past five transmissions, and determines that the image is to be transmitted using the TCP.

Based on a result of the determination, the screen processor 12 compresses the corresponding mesh image (step S82), and the first transmitter 14 transmits the compressed mesh image by using the TCP (step S84). Next, the screen processor 12 stores the mesh image in the previous image in association with the mesh position in the corresponding area in the management table 112, shifts the transmission histories H1 to H4 to the positions of H2 to H5, and stores, in the transmission history H1, A indicating the TCP transmission that guarantees the reliability (step S86).

In step S80, upon determining that at least one of the transmission histories H1 to H5 of the mesh image of the area does not indicate N (non-transmission) by referring to the management table 112, the determiner 13 determines that a corresponding mesh image was transmitted in the recent five transmissions. The determiner 13 then regards the screen change in the mesh image as being frequent and determines that a compressed mesh image thereof is to be transmitted using the UDP.

The screen processor 12 compresses the corresponding mesh image, based on a result of the determination (step S88), and the second transmitter 15 transmits the compressed mesh image by using the UDP (step S90). Next, the screen processor 12 stores the mesh image in the previous image in association with the mesh position in the area in the management table 112, the transmission histories H1 to H4 are shifted to the positions of H2 to H5, and stores, in the transmission history H1, B indicating a transmission using the UDP that does not guarantee the reliability (step S92).

If the determiner 13 determines, in step S78, that there is no change in the mesh image of the corresponding area on the desktop screen Dp, the determiner 13 determines the states of the transmission histories of the area in the management table 112 (step S94). When the determiner 13 determines that the transmission histories H1 to H4 indicate N (non-transmission), and the oldest history H5 indicates B (the UDP that does not guarantee the reliability), there is no guarantee that an image transmitted in the last transmission has arrived at the client apparatus 20, because of the transmission of the UDP that does not guarantee the reliability. There is a possibility that a change is not frequently made on the screen in the future, as well. Thus, in this case, even when there is no change on the screen of a mesh image, it is preferable to normalize the image of a desktop screen displayed at the client apparatus 20, by using the first transmitter 14 to perform transmission using the TCP that guarantees the reliability.

Accordingly, upon determining, in step S94, that the transmission histories H1 to H4 indicate N (non-transmission), and the transmission history H5 indicates B (UDP transmission), the determiner 13 compresses the corresponding mesh image (step S96). The first transmitter 14 transmits the compressed mesh image by using the TCP (step S98). Next, the screen processor 12 stores the mesh image in the previous image in association with the mesh position in the area in the management table 112, shifts the transmission histories H1 to H4 to the positions of H2 to H5, and stores, in the transmission history H1, A indicating a TCP transmission that guarantees the reliability (step S100).

On the other hand, upon determining, in step S94, that the condition that the transmission histories H1 to H4 indicate N (non-transmission) and the transmission history H5 indicates B (UDP transmission) is not satisfied, the determiner 13 determines that the mesh image is not to be transmitted to the client apparatus 20. In this case, the screen processor 12 shifts the transmission histories H1 to H4 in the management table 112 to the positions of H2 to H5 and records N indicating a non-transmission to the transmission history H1 (step S102).

After the processes in steps S86, S92, S100, and S102, the determiner 13 determines whether or not there is an unprocessed mesh image (step S104). If the determiner 13 determines that there is an unprocessed mesh image, the process returns to step S74 in which the determiner 13 obtains the unprocessed mesh image and executes the processes in and after step S74.

Upon determining, in step S104, that there is no unprocessed mesh image, the determiner 13 determines whether or not the VDI is disconnected (step S26). When it is determined that the VDI is not disconnected, the process returns to step S10, and the loop processing in and after step S10 is repeatedly executed until the VDI is disconnected. If it is determined in step S26 that the VDI is disconnected, this processing ends.

In the above-described screen transmission processing according to the fourth example, screen data for an area where an update of a desktop screen is rare is transmitted using the TCP that guarantees the communication reliability, and screen data for an area where an update is frequently performed is transmitted using the UDP that does not guarantee the communication reliability and that is high in transmission speed. This makes it possible to reliably transmit screen data to be transmitted, while maintaining the communication performance.

### FIFTH EXAMPLE

Screen transmission processing according to a fifth example will be described in conjunction with an example in which major position information about mouse operations at the client apparatus is transmitted using a TCP that guarantees the communication reliability, and detailed position information about mouse operations is transmitted using a UDP that does not guarantee the communication reliability.

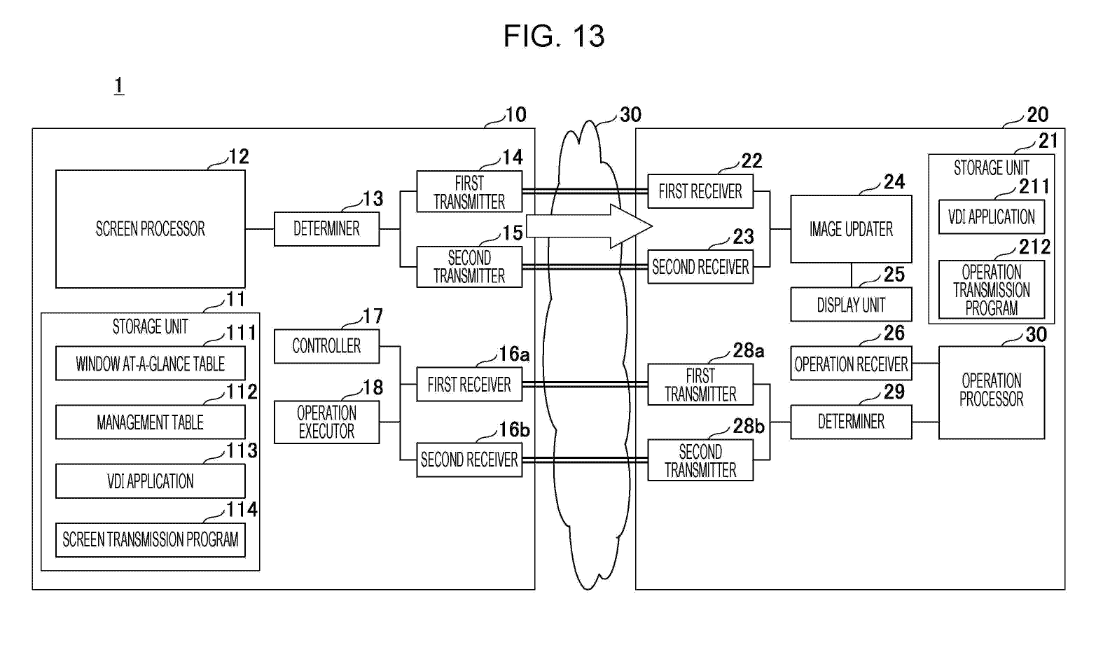

After an example of the functional configurations of the client apparatus 20 and the server apparatus 10 which execute the screen transmission processing according to the fifth example is described, a description will be given of an example of the screen transmission processing according to the fifth example. FIG. 13 is a diagram illustrating another example of the functional configurations of the client apparatus 20 and the server apparatus 10 according to the embodiment.

Since the individual elements in the client apparatus 20 and the server apparatus 10 illustrated in FIG. 13 have functions that are the same as or similar to those of the individual elements in the client apparatus 20 and the server apparatus 10 illustrated in FIG. 2 when they are denoted by the same reference numerals, descriptions of the functions are not given hereinafter.

The client apparatus 20 illustrated in FIG. 13 includes a first transmitter 28a, a second transmitter 28b, a determiner 29, and an operation processor 30, in addition to the storage unit 21, the first receiver 22, the second receiver 23, the image updater 24, the display unit 25, and the operation receiver 26 in the client apparatus 20 illustrated in FIG. 2. The storage unit 21 stores therein an operation transmission program 212 in addition to the VDI application 211 illustrated in FIG. 2. The operation transmission program 212 causes the client apparatus 20 to execute operation transmission processing described below.

The first transmitter 28a transmits data by using a first communication protocol that has a mechanism for guaranteeing the communication reliability and with which data is reliably transferred to the server apparatus 10 at a receiving end through re-transmission when data is lost. The second transmitter 28b transmits data by using a second communication protocol that does not have a mechanism for guaranteeing the communication reliability and with which the speed of the data transmission is increased.

The determiner 29 determines whether data in question is data that has to be processed by the server apparatus 10 at the receiving end or data that does not have to processed thereby.

The server apparatus 10 illustrated in FIG. 13 includes a first receiver 16a, a second receiver 16b, and an operation executor 18, in addition to the storage unit 11, the screen processor 12, the determiner 13, the first transmitter 14, the second transmitter 15, and the controller 17 included in the server apparatus 10 illustrated in FIG. 2.

The first receiver 16a receives data transmitted from the first transmitter 28a in the client apparatus 20 by using the first communication protocol that guarantees the communication reliability. The second receiver 16b receives data transmitted from the second transmitter 28b in the client apparatus 20 by using the second communication protocol that does not guarantee the communication reliability. When data does not arrive, the first receiver 16a waits for a certain amount of time and then transmits a re-transmission request to the client apparatus 20. When the second receiver 16b does not have a mechanism for sensing whether or not data arrives, and when data does not arrive, the second receiver 16b disregards the data. Based on the data received from the client apparatus 20, the operation executor 18 executes an operation on the desktop screen Dp.

[Screen Transmission Processing]

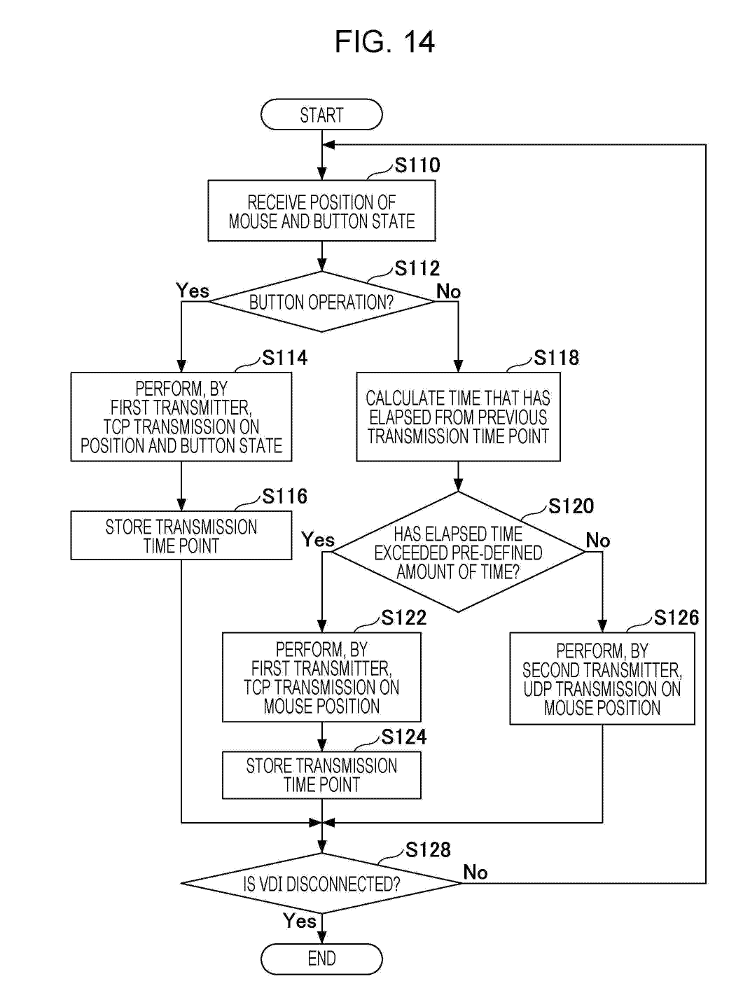

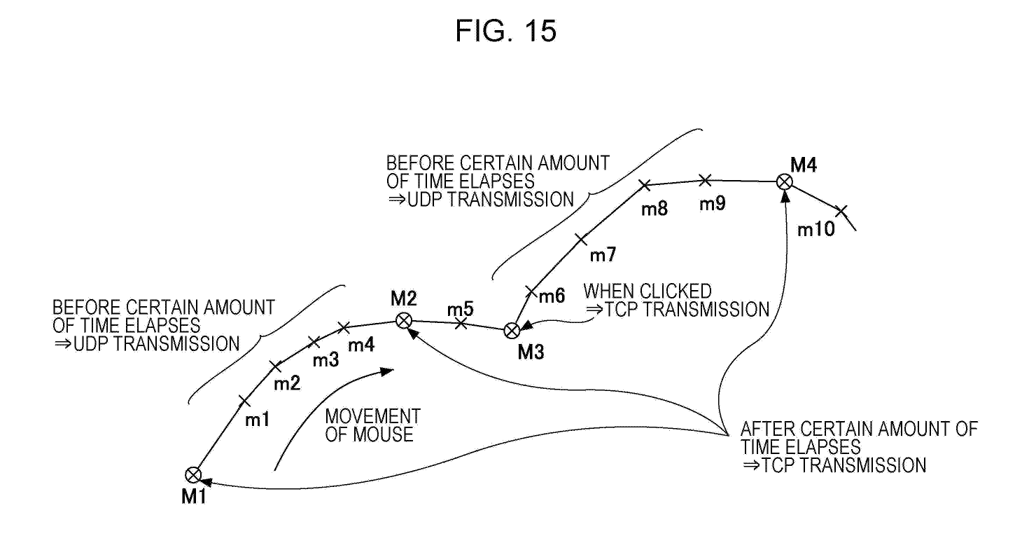

Next, an example of the screen transmission processing according to the fifth example will be described with reference to FIGS. 14 and 15. FIG. 14 is a flowchart illustrating an example of the screen transmission processing according to the fifth example. FIG. 15 is a diagram illustrating operation transmission processing according to the fifth example. This processing is mainly executed by the client apparatus 20.

In the fifth example, a description will be given in conjunction with an example of mouse operations performed at the client apparatus 20. The user operations, however, are not limited to mouse operations and may be any input operations, such keyboard operations or touch-panel operations, and this screen transmission processing is applicable to any of such input operations.

In the fifth example, with respect to mouse movement due to user operations, major position information (for example, M1, M2, M4 . . . ) of a mouse operation for each elapse of a certain period of time and major position information (for example, M3), such as a click operation, are transmitted using the TCP that guarantees the communication reliability, as illustrated in FIG. 15. Detailed position information (for example, m1, m2, m3, m4, . . . , and m10) of the mouse operations is transmitted using the UDP that does not guarantee the communication reliability.

It is important that major position information about a mouse operation, such as a click operation, be transmitted from the client apparatus 20 to the server apparatus 10. On the other hand, part of position information of a mouse during minute movement of the mouse may or may not be transmitted to the server apparatus 10. Accordingly, an event involving a button operation and a mouse event (such as M1, M2, M3, or M4 in FIG. 15) involving a mouse operation for each elapse of a certain amount of time are transmitted using the TCP that guarantees the communication reliability, and other mouse movement events (such as m1 to m10 in FIG. 15) are transmitted using the UDP that does not guarantee the communication reliability and that is high in transmission speed

During a mouse operation, a mouse event is transmitted from the client apparatus 20 to the server apparatus 10. As illustrated in FIG. 14, the operation receiver 26 receives a mouse operation to obtain position information of the mouse and a button state (step S110). Next, the determiner 29 determines whether or not the received operation is a button operation (step S112). When the determiner 29 determines that the received operation is a button operation, the first transmitter 28a transmits the received position information of the mouse and information of the button state by using the TCP that guarantees the communication reliability (step S114). The first transmitter 28a stores a transmission time point in the storage unit 21 (step S116).

If the determiner 29 determines that the received operation is not a button operation in step S112, the operation processor 30 calculates a time that has elapsed from the previous transmission time point (step S118).

The determiner 29 determines whether or not the elapsed time has exceeded a pre-defined amount of time (step S120). If the determiner 29 determines that the elapsed time has exceeded the pre-defined amount of time, the first transmitter 28a transmits the position information of the mouse event by using the TCP that guarantees the communication reliability (step S122). This is to ensure that the position of the mouse is reflected in the server apparatus 10, since the time that has elapsed from the previous transmission time point has exceeded the pre-defined time.

On the other hand, when the determiner 29 determines that the elapsed time has not exceeded the pre-defined time in step S120, the second transmitter 28b transmits the position information of the mouse event by using the UDP that does not guarantee the communication reliability (step S126). In this case, since not much time has elapsed from the previous transmission, there is no considerable problem even when the movement of the mouse is not transmitted to the server apparatus 10. Hence, the mouse position information of the mouse event is transmitted using the UDP that does not guarantee the communication reliability and that is high in transmission speed.

After the processes in steps S116, S124, and S126, the determiner 13 determines whether or not the VDI is disconnected (step S128). When it is determined that the VDI is not disconnected, the process returns to step 5110 in which a next mouse operation is received, and the loop processing in and after step 5110 is repeatedly executed until the VDI is disconnected. When it is determined in step S128 that the VDI is disconnected, this processing ends.

In the above-described screen transmission processing according to the fifth example, it is important that major information, such as information about click operations, in the client apparatus 20 be transmitted from the client apparatus 20 to the server apparatus 10. Part of the position information of the mouse during minute movement of the mouse may be transmitted to the server apparatus 10. Accordingly, an event involving a button operation and a mouse event for each elapse of a certain amount of time are transmitted using the TCP that guarantees the communication reliability, and other mouse movement events are transmitted using the UDP that does not guarantee the communication reliability and that is high in transmission speed. This makes it possible to reliably transmit screen data to be transmitted, while maintaining communication performance.

In the screen transmission/reception system 1 according to the embodiment, when it is determined that the processing can be continued even when data does not arrive at a transmission destination, the transmitting end that sends out data to the network 40 selects transmitting the data with a high speed by using the second communication protocol that does not guarantee the reliability. This makes it possible to improve the performance of a VDI.

With respect to data to be received using the second communication protocol, the receiving end does not involve sensing loss of data and does not involve the certain waiting time for determining whether or not delay of the arrival of transmitted data is due to loss. Thus, it is possible to further improve the performance of the VDI.

A screen transmission program, a screen transmission method, and a screen transmission/reception system have been described above in conjunction with the embodiment. However, the screen transmission program, the screen transmission method, and the screen transmission/reception system in the present disclosure are not limited to the above-described embodiment, and various modifications and improvements are possible within the scope of the present disclosure. When the number of embodiments and modifications is two or more, they may be combined together, as long as such a combination does not cause contradiction.

The server apparatus 10 in a cloud may execute part of the processing for the desktop screen, and a plurality of computers in a network system in which terminals execute other processing may cooperate with each other to perform a series of processing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A screen transmission system, comprising:
a first memory; and
a first processor coupled to the first memory, the first processor configured to:
transmit first part of screen data by using a first communication protocol; and
transmit second part of the screen data by using a second communication protocol that is higher in transmission speed and lower in communication reliability than the first communication protocol.

2. The screen transmission system according to claim 1, wherein
the first processor is further configured to:
transmit screen data relevant to a first area corresponding to an active window as screen data of the first part; and
transmit screen data relevant to a second area other than the first area as screen data of the second part.

3. The screen transmission system according to claim 1, wherein
the first processor is further configured to:
transmit, by using the first communication protocol, screen data of the first part when the screen data of the first part has changed from previous screen data; and
transmit, by using the second communication protocol, screen data of the second part when the screen data of the second part has changed from previous screen data.

4. The screen transmission system according to claim 1, wherein
the first processor is further configured to:
transmit, as screen data of the first part, screen data relevant to a key frame indicating an image of an entire screen; and
transmit, as screen data of the second part, screen data relevant to a predicted frame indicating an image of a difference from the key frame.

5. The screen transmission system according to claim 1, wherein
the first memory is configured to:
store, for a predetermined number of transmissions, transmission history of screen data relevant to each of a plurality of divided images obtained by dividing an image of a screen, and
the first processor is further configured to:
transmit, as screen data of the first part, screen data of a first divided image of the plurality of divided images when screen data of the first divided image has changed from a previous screen data and the screen data of the first divided image has not been transmitted in the predetermined number of transmissions; and
transmit, as screen data of the second part, screen data of a second divided image of the plurality of divided images when screen data of the second divided image has changed from a previous screen data and the screen data of the second divided image has been transmitted in at least one of the predetermined number of transmissions.

6. The screen transmission system according to claim 1, further comprising:
a first apparatus including:
the first memory; and
the first processor; and
a second apparatus including:
a second memory; and
a second processor coupled to the second memory, the second processor configured to:
receive screen data of the first part;
receive screen data of the second part; and
update an image of a screen based on the received screen data of the first part and the received screen data of the second part.

7. The screen transmission system according to claim 6, wherein
the second processor is further configured to:
receive operation events on the screen;
transmit position information of an operation event for each predetermined amount of time and a particular operation event among the received operation events to the first apparatus by using the first communication protocol; and
transmit position information of the received operation events other than the operation event for each predetermined amount of time and the particular operation event to the first apparatus by using the second communication protocol.

8. The screen transmission system according to claim 1, wherein the first communication protocol is the Transmission Control Protocol (TCP) and the second communication protocol is the User Datagram Protocol (UDP).

9. A screen transmission method, comprising:
transmitting, by a first computer, first part of screen data by using a first communication protocol; and
transmitting second part of the screen data, which is different from the first part, by using a second communication protocol that is higher in transmission speed and lower in communication reliability than the first communication protocol.

10. The screen transmission method according to claim 9, further comprising:
transmitting screen data relevant to a first area corresponding to an active window as screen data of the first part; and
transmitting screen data relevant to a second area other than the first area as screen data of the second part.

11. The screen transmission method according to claim 9, further comprising:
transmitting, by using the first communication protocol, screen data of the first part when the screen data of the first part has changed from previous screen data; and
transmitting, by using the second communication protocol, screen data of the second part when the screen data of the second part has changed from previous screen data.

12. The screen transmission method according to claim 9, further comprising:
transmitting, as screen data of the first part, screen data relevant to a key frame indicating an image of an entire screen; and
transmitting, as screen data of the second part, screen data relevant to a predicted frame indicating an image of a difference from the key frame.

13. The screen transmission method according to claim 9, further comprising:
storing, for a predetermined number of transmissions, transmission history of screen data relevant to each of a plurality of divided images obtained by dividing an image of a screen;
transmitting, as screen data of the first part, screen data of a first divided image of the plurality of divided images when screen data of the first divided image has changed from a previous screen data and the screen data of the first divided image has not been transmitted in the predetermined number of transmissions; and
transmitting, as screen data of the second part, screen data of a second divided image of the plurality of divided images when screen data of the second divided image has changed from a previous screen data and the screen data of the second divided image has been transmitted in at least one of the predetermined number of transmissions.

14. The screen transmission method according to claim 9, further comprising:
receiving, by a second computer, screen data of the first part;
receiving, by the second computer, screen data of the second part; and
updating, by the second computer, an image of a screen based on the received screen data of the first part and the received screen data of the second part.

15. The screen transmission method according to claim 14, further comprising:
receiving, by the second computer, operation events on the screen;
transmitting, by the second computer, position information of an operation event for each predetermined amount of time and a particular operation event among the received operation events to the first apparatus by using the first communication protocol; and
transmitting, by the second computer, position information of the received operation events other than the operation event for each predetermined amount of time and the particular operation event to the first apparatus by using the second communication protocol.

16. A non-transitory computer-readable recording medium having stored therein a program that causes a computer to execute a process, the process comprising:
transmitting first part of screen data by using a first communication protocol; and
transmitting second part of the screen data, which is different from the first part, by using a second communication protocol that is higher in transmission speed and lower in communication reliability than the first communication protocol.

17. The non-transitory computer-readable recording medium according to claim 16, further comprising:
transmitting screen data relevant to a first area corresponding to an active window as screen data of the first part; and
transmitting screen data relevant to a second area other than the first area as screen data of the second part.

18. The non-transitory computer-readable recording medium according to claim 16, further comprising:
transmitting, by using the first communication protocol, screen data of the first part when the screen data of the first part has changed from previous screen data; and
transmitting, by using the second communication protocol, screen data of the second part when the screen data of the second part has changed from previous screen data.

19. The non-transitory computer-readable recording medium according to claim 16, further comprising:
transmitting, as screen data of the first part, screen data relevant to a key frame indicating an image of an entire screen; and
transmitting, as screen data of the second part, screen data relevant to a predicted frame indicating an image of a difference from the key frame.

20. The non-transitory computer-readable recording medium according to claim 16, further comprising:
storing, for a predetermined number of transmissions, transmission history of screen data relevant to each of a plurality of divided images obtained by dividing an image of a screen;
transmitting, as screen data of the first part, screen data of a first divided image of the plurality of divided images when screen data of the first divided image has changed from a previous screen data and the screen data of the first divided image has not been transmitted in the predetermined number of transmissions; and
transmitting, as screen data of the second part, screen data of a second divided image of the plurality of divided images when screen data of the second divided image has changed from a previous screen data and the screen data of the second divided image has been transmitted in at least one of the predetermined number of transmissions.
